(19) United States
(12) Patent Application Publication
(10) Pub. No.: US 2014/0078802 A1
(43) Pub. Date: Mar. 20, 2014

(54) DC/AC INVERTER TO CONVERT DC CURRENT/VOLTAGE TO AC CURRENT/VOLTAGE

(71) Applicant: Ziya Ozkan, Ankara (TR)

(72) Inventor: Ziya Ozkan, Ankara (TR)

(21) Appl. No.: 13/615,672

(22) Filed: Sep. 14, 2012

(51) Int. Cl. H02M 7/5387

(52) U.S. Cl. 363/132

(57) ABSTRACT

A DC/AC inverter is disclosed having two DC input terminals (1, 2), between which are connected an energy buffer capacitor (C), two output voltage terminals (3, 4) connected to filter section, switch configuration comprising the active switches (S1-S6), and freewheeling diodes (D1-D6) between the output voltage terminals (3, 4) and DC input terminals (1, 2) to provide real and/or reactive power to a public or islanded electric network. It is provided that, capacitive leakage currents occurring on the generator side be avoided while conserving high efficiency. This is achieved in that a freewheeling current path, is established for the line current (I_{N}) to freewheel through one of the freewheeling diodes (D3, D6) in conjunction with one of their respective parallel semiconductor switches (S3, S6) when the two output voltage terminals (3, 4) are decoupled from the DC input terminals (1, 2).

### BACKGROUND OF THE INVENTION

1. Field of the Invention

The present invention relates to a DC/AC inverter to convert DC current/voltage into AC current/voltage as shown in FIG. 1. Such types of inverters are used to feed public electric network or to constitute an islanded electric network. These inverters are suitable for electric network connected DC voltage/current energy sourced applications such as fuel cell and photovoltaic systems.

2. Description of the Prior Art

The energy injection of DC/AC inverters to an existing AC electric network is based on generating sinusoidal current depending on the voltage of the electric network. Besides, the establishment of an islanded electric network with DC/AC inverters is achieved by providing preferably sinusoidal voltage with fixed frequency and amplitude.

In addition to real power provision capability, reactive power provision capability of a DC/AC inverter is preferable to meet the reactive power requirements of local loads or to prevent voltage rise at the point of common coupling.

DC/AC inverters connected to a public electric network or utilized in an islanded electric network should have high efficiency of energy conversion, low volume, lightness, and low cost. Besides, systems utilizing these inverters should maintain human and electric network safety by preventing capacitive leakage currents on the generator side causing electro-magnetic compatibility (EMC) problems especially in photovoltaic systems.

The low voltage connection of sources or energy storage systems having DC current/voltage to an electric network can be realized via transformer-based or transformerless DC/AC inverters.

Since transformer-based DC/AC inverters provide galvanic isolation, they have negligible capacitive leakage currents on the generator side. Thus, EMC problems due to leakage currents are minimized in transformer-based systems. However, transformer-based DC/AC inverters suffer from the core and copper losses of the transformer. Moreover, inclusion of a transformer increases the cost, size, and weight. The non-existence of transformer core and copper losses in transformerless inverters provide an increase in energy conversion efficiency, and decrease in the cost, size, and weight. Therefore, payback period of systems with transformerless inverters are shorter than systems with transformer-based inverters. Despite such advantages of transformerless DC/AC inverters, systems utilizing these inverters, especially photovoltaic energy sourced electric network connected systems, may encounter EMC problems caused by capacitive leakage currents. Utilized DC/AC inverter topology and related switching technique in such systems have primary importance to suppress capacitive leakage currents and related EMC problems.

The conventional and widely utilized H-bridge DC/AC inverter topology shown in FIG. 2 has two switching techniques. These are unipolar modulation and bipolar modulation. The unipolar modulation of the H-bridge DC/AC inverter topology has certain advantages that increase energy conversion efficiency such as three-level output voltage and no energy backflow to the DC bus capacitor (C). Although it is applicable in transformer-based DC/AC inverters due to these advantages, the H-bridge DC/AC inverter topology with unipolar modulation switching technique restricts its utilization as a transformerless DC/AC inverter because of the EMC problems caused by capacitive leakage currents especially in grid connected photovoltaic source applications. In bipolar modulation of the H-bridge topology, EMC problems are not dominant. However, line current ripple is increased due to two-level output voltage characteristic or such a characteristic yields a requirement of higher inductance value for the same peak line current ripple value. The increase in the line current ripple or in the value of the required filter inductance of bipolar modulation decrease the energy conversion efficiency and increase the cost as compared to unipolar modulation of the H-bridge topology.

A prior art circuit configuration comprising an H-bridge and an additional switch S5″ connected to positive DC bus rail as shown in FIG. 3 is described in U.S. Pat. No. 7,411,802 B2. This circuit avoids the high frequency capacitive leakage currents on the generator side of that are existent in the unipolar modulation of the H-bridge. This is achieved by the fact that at freewheeling states decoupling of AC and DC sides is provided. Moreover, the output voltage is three-level so that related core and copper losses are reduced on the filter inductors and there is no backflow of the energy to the DC bus capacitor (C) so that efficiency is increased. However, at each time interval that the output voltage terminals are connected to the DC bus terminals, said active state, the number of semiconductor on the line current path is three, resulting in energy conversion efficiency deterioration thereof.

In the present invention, besides capacitive leakage currents are avoided by decoupling output voltage terminals (3, 4) from the DC input terminals (1, 2) (shown in FIG. 1) at zero states, the number of semiconductors on the line current path at active states is reduced to two for half of the electric network period. This reduction of number of semiconductors on the line current path increases the energy conversion efficiency. Besides the low leakage current and high energy conversion efficiency characteristics, the present invention provides a DC/AC inverter with reactive provision capability which is nonexistent in the prior art shown in FIG. 3. In addition to real power, reactive power provision capability of a grid connected DC/AC inverter is preferable to meet the reactive power requirements of the local loads or to regulate the voltage at the point of common coupling.

### BRIEF SUMMARY OF THE INVENTION

The aim of the present invention is to provide a high efficiency transformerless DC/AC inverter with reactive power provision capability either in a public electric network connected mode or in an islanded mode while preventing high frequency leakage currents on the generator side.

To achieve the objective of prevention of high leakage currents on the generator side, there is a DC/AC inverter circuit configuration in accordance with the present invention as shown in FIG. 1. The circuit consists of an input capacitor (C), configuration of the switches S1-S6 and their respective anti parallel freewheeling diodes D1-D6, and filter section to suppress high frequency content of the line current. The prevention of leakage current on the generator side is achieved by decoupling alternating current voltage circuit from the direct current voltage circuit at freewheeling states. In accordance with the invention, the freewheeling current flows through a freewheeling current path determined by the polarity of the freewheeling current when the path is provided in the freewheeling states.

With the prevention of capacitive leakage currents, safety is increased for direct current circuit components, for electric network, and for persons. Moreover, reliability and lifetime are increased as the generator side photovoltaic modules are not exposed to high leakage currents and additional losses due to leakage currents are nonexistent even the circuit does not include a transformer.

Therefore, preferred embodiment of the circuit of the invention is a transformerless inverter with low cost and high efficiency as compared to transformer-based units.

In the present invention, size of the filter chokes and related losses are reduced as compared to H-bridge bipolar modulation. This is achieved by means of pulse width modulation of the switches and the H-bridge unsymmetrical modulation voltage output characteristics of the invention.

The circuit of the present invention can be designed and implemented to operate at unity power factor. In this configuration, the semiconductors can be optimized for high efficiency as S1, S2, S4, S5 being MOSFETs and their respective freewheeling diodes D1, D2, D4, D5 being their body diodes. The diodes D1, D2, D4, and D5 can be also nonexistent at unity power factor operation design. The switches S3, S6 can be chosen as IGBTs wherein their respective diodes (D3, D6) correspond to fast built-in diodes or these freewheeling diodes can be fast external diodes.

To increase efficiency in the design with reactive power provision capability, meaning design for non-unity power factor operation, the switches S1-S6 can be selected as IGBTs and the respective freewheeling diodes D1-D6 can be fast built-in diodes of the IGBTs or fast diodes can be mounted externally. Since all the diodes carries are intended to carry pulsed current in this kind of operation, such embodiments of fast diodes yield better commutation characteristics.

The proposed circuit within the scope of this invention provides lower conduction losses as compared to the transformerless DC/AC inverter topology described in U.S. Pat. No. 7,411,802 B2 and shown in FIG. 3. This is achieved by means of less number of switches on the line current path at active states when the electric network voltage is positive. Thus, the energy conversion efficiency is increased in the present invention.

The implementation of this circuit configuration can be performed for one-phase or multi-phase either in an electric network connected mode or in an island mode.

In dependent claims, further advantageous features and the implementations are given.

The invention and the advantages will be described in further detail with reference to the drawings.

### BRIEF DESCRIPTION OF THE DRAWINGS

The present invention is made more apparent using preferred embodiments with reference to the related drawings without the intention of limiting the scope of the invention. In the drawings:

FIG. 1 shows an illustration of a circuit arrangement of a DC/AC inverter in accordance with the invention,

FIG. 2 shows an illustration of a prior art DC/AC inverter circuit arrangement,

FIG. 3 shows an illustration of a prior art DC/AC inverter circuit arrangement,

FIG. 4 shows an illustration of a single-phase electric network voltage and injected current in accordance with the circuit arrangement in FIG. 1,

FIG. 5 shows an illustration of the circuit arrangement shown in FIG. 1 with active state current path during time region R1 in FIG. 4,

FIG. 6 shows an illustration of the circuit arrangement shown in FIG. 1 with zero state current path during time region R1 or R4 in FIG. 4,

FIG. 7 shows an illustration of the circuit arrangement shown in FIG. 1 with active state current path during time region R3 in FIG. 4,

FIG. 8 shows an illustration of the circuit arrangement shown in FIG. 1 with zero state current path during time region R2 or R3 in FIG. 4,

FIG. 9 shows an illustration of the circuit arrangement shown in FIG. 1 with active state current path during time region R2 in FIG. 4, and

FIG. 10 shows an illustration of the circuit arrangement shown in FIG. 1 with active state current path during time region R4 in FIG. 4.

### DETAILED DESCRIPTION OF THE INVENTION

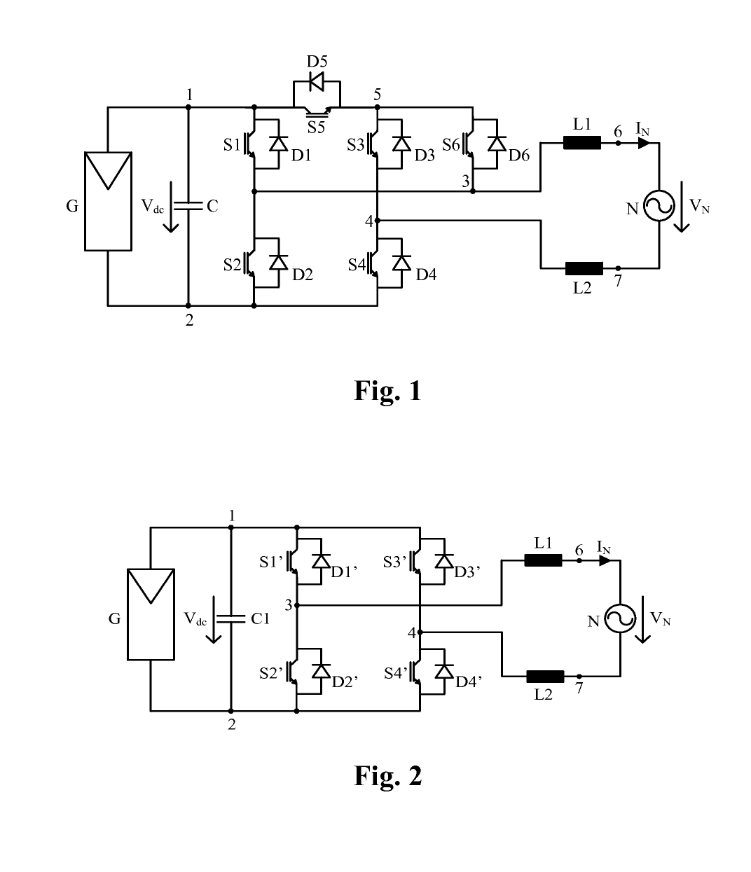

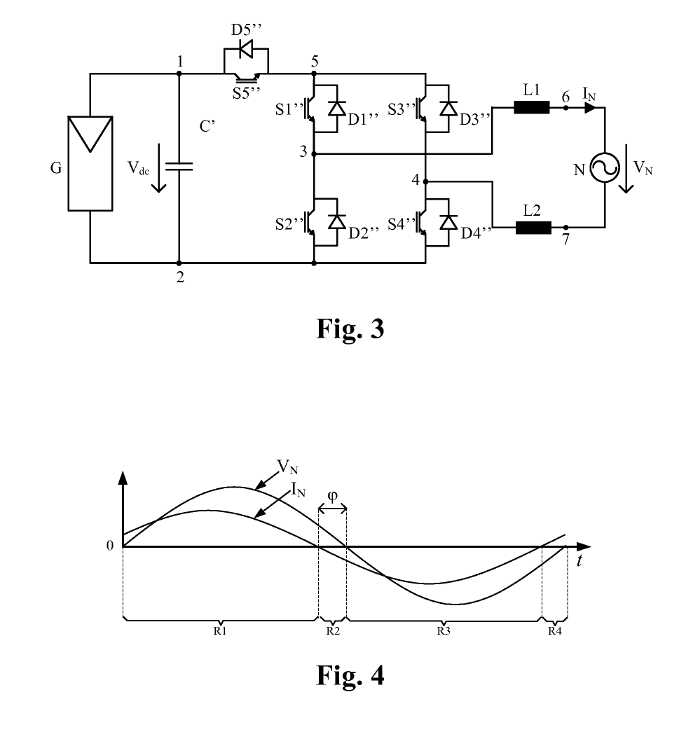

In FIG. 1, a transformerless DC/AC inverter is shown in accordance with the present invention. This circuit allows for a method to convert DC current/voltage to AC current/voltage with reactive power provision capability, improved efficiency, and reduced leakage currents on the generator side.

The DC/AC inverter shown in FIG. 1 has a DC voltage input with positive and negative terminals 1, 2 respectively, high frequency voltage output terminals 3, 4, and AC voltage output with terminals 6, 7. Connected in parallel to the DC input terminals 1, 2, there is an input energy buffer capacitor C and an energy source G. A half bridge configuration comprising switches 51 and S2 is connected between the terminals 1 and 2. Switch S5 is connected between the nodal point 1 and 5 to allow current flow from the nodal point 1 to nodal point 5 when triggered. Between the nodal points 5 and 2, another half bridge configuration comprising switches S3 and S4 is connected. A switch S6 is connected between the nodal point 5 and the midpoint called nodal point 3 of the first half bridge that consists of S1 and S2 to allow current flow from the nodal point 5 to the nodal point 3. All the switches S1-S6 have anti-parallel diodes D1-D6.

The high frequency voltage output terminals 3, 4, also called filter section input terminals, are connected to the filter section residing between the so called the filter section input terminals 3, 4 and filter section output terminals 6, 7. The filter circuit, which is the circuit residing between the filter input terminals 3, 4, and filter output terminals 6, 7, has two filter inductors L1, L2 preferably with equal ratings. The filter inductor L1 is connected in between the filter circuit input terminal 3 and the filter circuit output terminal 6. The other filter inductor L2 is connected in between the filter circuit input terminal 4 and filter circuit output terminal 7. The filter circuit output terminals 6, 7 are connected to an electric network N to provide preferably sinusoidal current/voltage for example at 50 Hz or 60 Hz.

Any known semiconductor switch such as MOSFETs, IGBTs or FETs can be used in principle for the realization of the switches S1-S6 of the DC/AC inverter in accordance with the present invention. The freewheeling diodes D1-D6 of the DC/AC inverter can be built-in diodes or they can be external diodes. However, to optimize the energy conversion efficiency the switches S1-S6 and the freewheeling diodes D1-D6 should be chosen accordingly. The switches S1-S6 and freewheeling diodes D1-D6 of the DC/AC inverter circuit can be selected according to reactive power provision capability intention in the design of the inverter. In other words, shown in FIG. 4, the value of the phase angle φ between the line current I_{N} and the electric network voltage V_{N} of the DC/AC inverter shown in FIG. 1 can be used to determine the type of the semiconductor switches S1-S6 and their anti-parallel diodes D1-D6 for the purpose of optimization of energy conversion efficiency of the DC/AC inverter in accordance with the invention.

When the reactive power provision capability is not desired in the implementation of the DC/AC inverter circuit of the present invention, in other words the inverter is designed to operate at phase angle φ ideally being zero, said unity power factor operation, MOSFETs are suitable for the realization of the semiconductor switches S1, S2, S4, and S5. This is due to the fact that, low on-state resistance of MOSFETs yields low losses.

In the embodiment of the design of the DC/AC inverter of the present invention for the unity power factor operation, the semiconductor switches S1, S2, S4, and S5 are clocked at high frequency (between 1 kHz and 1 MHz, for example 20 kHz) to modulate the output voltage (the voltage between the nodal points 3 and 4) of the inverter. At unity power factor operation, to provide zero output voltage states (in other words, the states when the voltage between the nodal points 3 and 4 is zero), said zero states, the switches S3 and S6 are clocked at the electric network frequency, for example at 50 Hz. In the case of unity power factor operation, since there is no backflow of electric energy from AC side to DC bus capacitor (C), the diodes D3 and D6 are sufficient to allow the flow of line current I_{N} at zero states. According to the sign of the line current I_{N}, one of the freewheeling diodes D3, D6 takes the line current I_{N} in conjunction with the one of the switches S3, S6 to establish a freewheeling path at zero states. To increase the efficiency characteristics, the freewheeling diodes D3 and D6 can be selected as fast diodes.

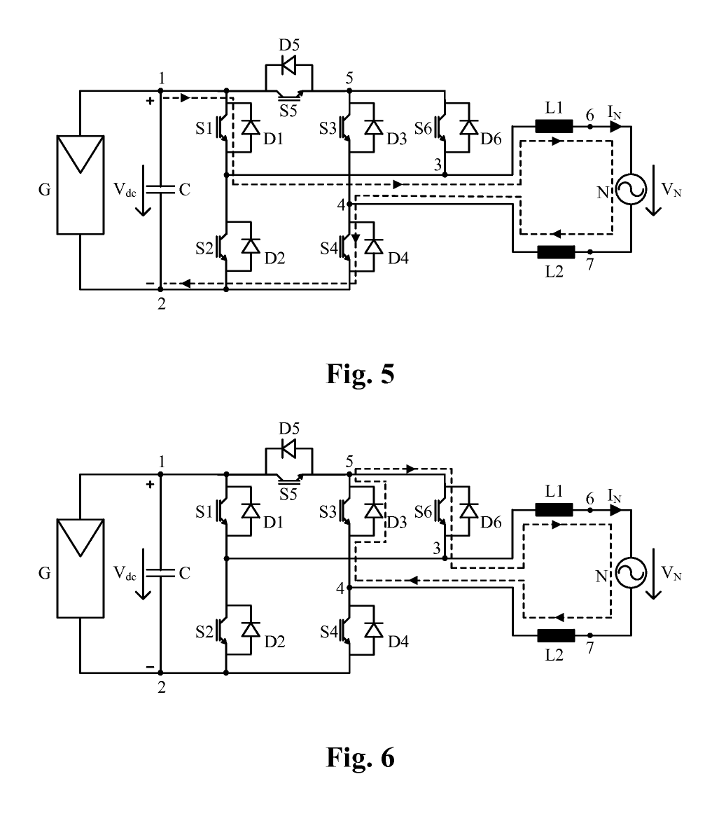

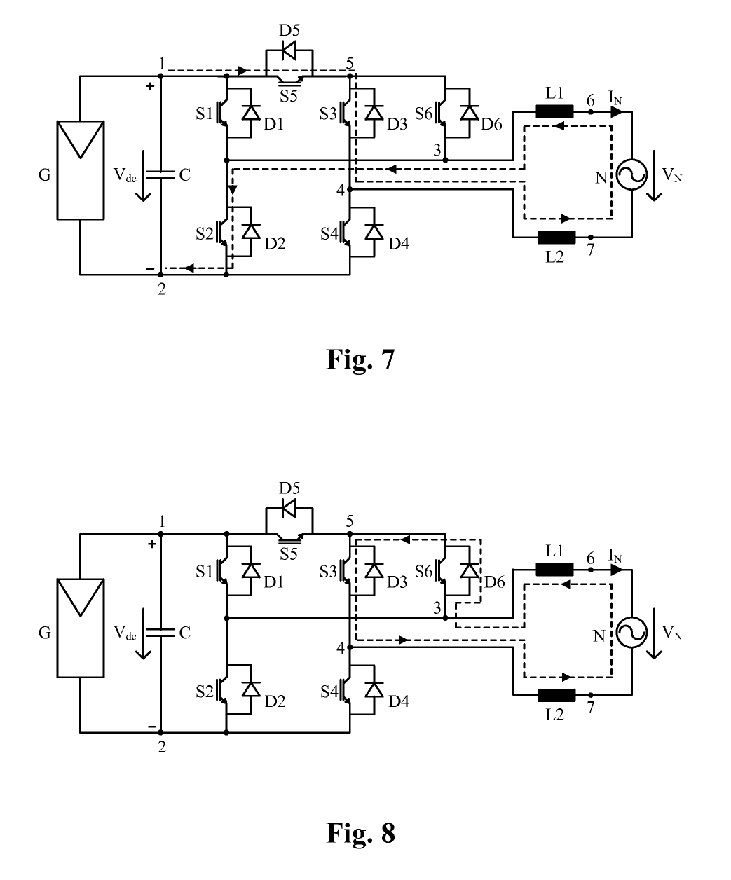

In unity power factor operation mode, the DC/AC inverter in accordance with the invention operates either in time region R1 or R3 shown in FIG. 4. In this mode, the phase angle φ is zero; therefore, the electric network voltage V_{N} and the inverter current I_{N} are aligned. While V_{N} and I_{N} are positive (corresponding to region R1 in FIG. 4 with phase angle φ being zero), the switches S1 and S4 are clocked and pulse-width modulated in synchronism at high frequency (between 1 kHz and 1 MHz) whereas they are switched-off in the other half time duration (when V_{N} and I_{N} are negative). In FIG. 5, the line current I_{N} path is illustrated for the condition of positive active state and positive line current values, in other words for the region R1 in FIG. 4. In this condition, the current flows through the switches S1 and S4. When commutated to zero state, the positive line current I_{N} flows from the path through the switch S6 and the diode D3, as shown in FIG. 6. In this condition, the DC input terminals 1, 2 and inverter output voltage terminals 3, 4 are decoupled from each other in accordance with the present invention. While V_{N} is negative (corresponding to region R3 in FIG. 4 with phase angle φ being zero), the switches S2 and S5 are clocked and pulse-width modulated in synchronism at high frequency, whereas they are switched-off when V_{N} is positive. The line current I_{N} path when the inverter provides negative output voltage (negative state) and the line current I_{N} is negative is shown in FIG. 7. In this condition, the line current I_{N} flows through the switches S2, S3, and S5. Zero states in the unity power factor operation mode in region R3 (when V_{N} and I_{N} are negative) are provided as shown in FIG. 8.

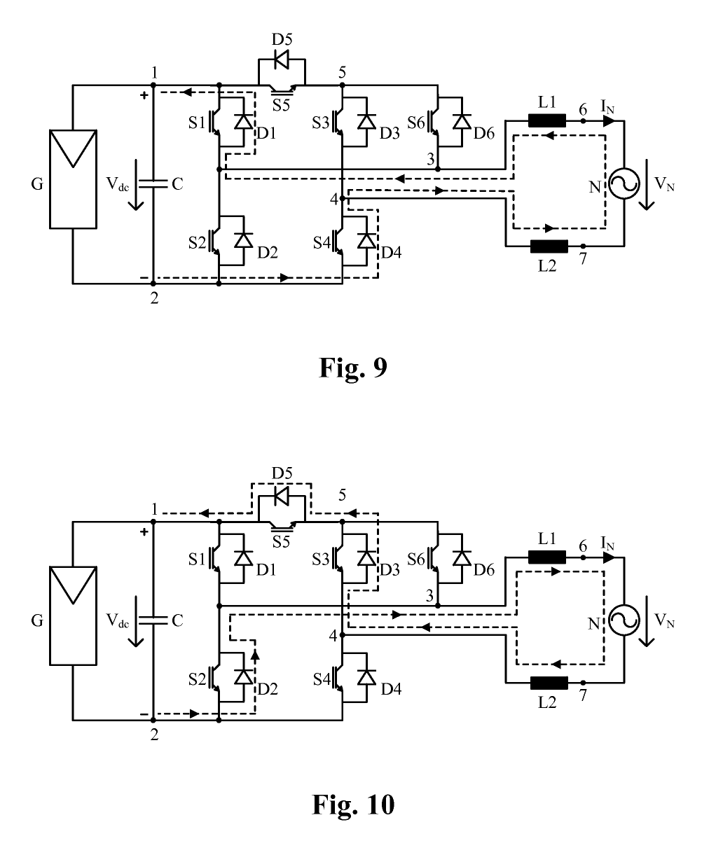

When the DC/AC inverter of the present invention is designed to be able to provide reactive power, the semiconductor switches S1-S6 should be preferably realized as IGBTs since MOSFETs have slow parasitic body diodes that introduce high switching losses. For reactive power provision capability, the DC/AC inverter in accordance with the invention should be able provide positive active states with negative I_{N} and negative active states with positive I_{N} that correspond to region R2 and region R4 respectively in FIG. 4. In FIG. 9, negative line current I_{N} path at positive active states is illustrated. On this path, the freewheeling diodes D1, D4 become forward biased and they provide current for the backflow of the electric energy to the DC bus capacitor C. In FIG. 10, positive line current I_{N} path at negative active state is illustrated. On this path, the freewheeling diodes D2, D3, and D5 become forward biased and they provide current for the backflow of the electric energy to the DC bus capacitor C. According to the sign of the line current I_{N}, zero states of the DC/AC inverter can be provided through the pairs S3, D6 or S6, D3 as shown in FIG. 6 and FIG. 8 with decoupling of DC input terminals 1, 2 and the inverter voltage output terminals 3, 4 in accordance with the invention. The freewheeling diodes D1-D6 of the DC/AC inverter should be fast diodes for low switching losses and high efficiency. Accordingly, these freewheeling diodes D1-D6 can be built-in diodes or they can be connected externally.

With the decoupling of DC and AC terminals at zero states, with the low number of semiconductors on the line current path both in active states and zero states, and with the three-level output voltage, the invention provides a low leakage current and high efficiency transformerless DC/AC inverter with reactive power provision capability.

### LIST OF NUMERALS (LIST OF PART NUMBERS)

1, 2 inverter DC input terminals

3, 4 inverter voltage output terminals

5 inverter intermediate nodal point

6, 7 AC electric network connection terminals

C input buffer capacitor

V_{dc} DC bus voltage

G generator

S1-S6 semiconductor switching elements

D1-D6 freewheeling elements

L1, L2 filter inductors

N either a public electric network or an islanded electric network

V_{N} electric network voltage

I_{N} electric network current

φ phase angle between electric network voltage and current

R1-R4 time regions based on the sign of electric network voltage and current

I claim:

1. A DC/AC inverter comprising two DC input connections (1, 2) in between which are connected an energy buffer capacitor (C), two output voltage nodal points (3, 4) connected to filter inductors (L1, L2), characterized in that a circuit configuration comprising semiconductor switches (S1-S6) and freewheeling diodes (D1-D6) connected in a manner that; a half bridge configuration comprising the switches S1 and S2 is connected between the DC input terminals 1 and 2, the semiconductor switch S5 is connected between the nodal point 1 and the nodal point 5 to allow current flow from the nodal point 1 to the nodal point 5 when the switch is triggered, between the nodal points 5 and 2 another half bridge is connected comprising switches S3 and S4, the switch S6 is connected between the nodal point 5 and the nodal point 3 to allow current flow from the nodal point 5 to the nodal point 3, and that, at least the freewheeling elements D3, D6 are connected in parallel to their respective switches S3, S6, with being provided decoupling of DC input terminals (1, 2) from the AC output voltage terminals (3, 4) at zero states.

2. The DC/AC inverter as claimed in claim 1, characterized by the parallel connection of the freewheeling diodes D1, D2, D4, and D5 to their respective switches S1, S2, S4, and S5.

3. The DC/AC inverter as claimed in claim 1, characterized by an implementation as a transformerless DC/AC inverter.

4. The DC/AC inverter as claimed in claim 2, characterized by an implementation as a transformerless DC/AC inverter.

5. The DC/AC inverter as claimed in claim 1, characterized by an implementation as a multiple phase DC/AC inverter.

6. The DC/AC inverter as claimed in claim 2, characterized by an implementation as a multiple phase DC/AC inverter.

7. A use of the DC/AC inverter as claimed in claim 1, as a public electric network connected DC/AC inverter.

8. A use of the DC/AC inverter as claimed in claim 2, as a public electric network connected DC/AC inverter.

9. A use of the DC/AC inverter as claimed in claim 2, as an island electric network connected DC/AC inverter.

10. The DC/AC inverter as claimed in claim 2, wherein: the reactive power provision capability is provided with the backflow of the electric energy as current to the DC bus capacitor C through either one of the sets of freewheeling elements (D1, D4) or (D2, D3, D5).

11. The DC/AC inverter as claimed in claim 2, wherein: a DC/DC regulator stage is connected to the input terminals 1, 2.

12. The method of converting DC current/voltage into AC current/voltage with the DC/AC inverter as claimed in claim 1, wherein: the switches S1 and S4 are switched at 1 kHz to 1 MHz in synchronism when the electric network voltage is positive, the switches S2 and S5 are switched at 1 kHz to 1 MHz in synchronism when the electric network voltage is negative, and the switches S3 and S6 are switched at electric network frequency which allows decoupling at freewheeling intervals.

13. The method as claimed in claim 10, characterized in that the high frequency switched switches S1, S2, S4, and S5 are triggered with pulse-width modulation.

14. A method for converting DC current/voltage electricity to AC current/voltage electricity with a DC/AC inverter as claimed in claim 1.

15. A method for converting DC current/voltage to AC current/voltage with a DC/AC inverter as claimed in claim 2.
